(19) United States
(12) Patent Application Publication
(10) Pub. No.: US 2003/0163309 A1
(43) Pub. Date: Aug. 28, 2003

(54) Speech dialogue system

(75) Inventors: Shigeru Yamada, Akashi (JP); Hayuru Ito, Akashi (JP); Yuji Kijima, Akashi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/368,386

(22) Filed: Feb. 20, 2003

(30) Foreign Application Priority Data
Feb. 22, 2002 (JP) 2002-046584

(51) Int. Cl. G10L 15/00

(52) U.S. Cl. 704/231

(57) ABSTRACT

In accordance with the present invention, there is provided a speech dialogue system having a speech recognition unit, a synthetic utterance generating unit, and a sub-sound generating unit. A speech uttered by a user is input into the speech recognition unit and analyzed, and resultant information is obtained. The synthetic utterance generating unit generates a system utterance based on the resultant information. The sub-sound generating unit generates a sub-sound which notifies the user whether the speech dialogue is in the state being able to accept the speech uttered by the user or not. As the user can know the state of the system by the sub-sound continuously radiated from a loudspeaker, the user can easily catch the timing to speak. By the sub-sound, a dialogue between the user and the speech dialogue system is smoothly promoted.

### BACKGROUND OF THE INVENTION

1. Field of the Invention

The present invention relates to a speech dialogue system for interfacing the user and the system in a form of spoken dialogue, and is particularly concerned with a speech dialogue system for carry out processing to promote a dialogue between the user and the system with a function indicating a period in which the speech uttered by the user can be accepted by the system.

2. Description of Related Art

The progress of the computer and software technologies in recent years allows the speech recognition technology to analyze speech uttered by a user and recognize the content of the speech. And the speech recognition technology has also become to be used in a speech dialogue system for recognizing and answering the inquiry from a user via a telephone. The speech dialogue system usually comprises a function to synthesize or utter audible information, such as a speech, in addition to a speech recognition function. Both functions allow the system to carry out the dialogue between the user and the system.

On the other hand, in the case of a dialogue between or among persons, the speakers often utter at the same time in the their dialogue. However the dialogue progresses smoothly through controlling the order of speech or a change of speaker by a linguistic meaning included in the end part of speech or a variation of an intonation and/or by a non-verbal communication meaning of such as body action or a look came over a face. Even in a case of a dialogue between persons via a media capable of communicating only a speech such as a telephone, the linguistic meaning allows a smooth progress of a dialogue, because the cultural code or rules in a dialogue are possessed by person.

Like the dialogue between persons, the speech dialogue system based on the cultural codes by the linguistic meaning or non-verbal meaning in a dialogue described above which promotes the smooth progress of the dialogue is preferable to be used in a speech dialogue between man and machine. But it is difficult to realize such a system by the current technology. However a technology making a speech dialogue between man and machine smoother is sought.

Referring to FIG. 1, a conventional speech dialogue system 700 and its operation are explained. The speech uttered by the user 701 is input into a microphone 702, and then converted to a speech signal, and sent to an acoustic processing unit 704 in which the speech signal is processed.

As the microphone 702 may collect the sounds of the speech uttered by the user 701 and the speech transmitted from a loudspeaker 714, the acoustic processing unit 704 should perform signal processings such as echo-canceling for subtracting a speech signal corresponding to a speech transmitted by the loudspeaker 714 from the speech signals input into the acoustic processing unit 704, and a normalization processing for normalizing a level of an extracted speech signal, namely the speech signal uttered by the user 701.

After these signal processings, the speech signal output from the acoustic processing unit 704 is then sent to a user-speech recognition unit 706 in which the words or phrases corresponding to the speech signal is recognized. Then a dialogue control unit 708 directs a system-utterance-content synthesizing unit 710 to synthesize a system-utterance information for responding to the linguistic meaning of the speech uttered by the user 701. The synthesized system-speech information is sent to a system-utterance generating unit 712, and converted to a system-utterance signal. The system-utterance signal is sent to a loudspeaker 714, and radiated as a speech uttered by the system 200. And then the speech radiated from the loudspeaker 714 is heard by the user 701.

Even in the conventional speech-dialogue system, the echo-canceling technology is adopted. The echo canceling technology can extracts a speech uttered by a user from a speech including speeches uttered by the user and the system, where the system utterance is input to the microphone 702 through the feedback loop comprising the loudspeaker 714 and the microphone. As the echo canceling can extract the user's speech from the speech including both the user's speech and the system-utterance, this echo-canceling technology can allow the system 200 to recognize correctively the speech uttered by the user even in the case that the user speaks some phrases when the system is in uttering. That is, the dialogue can be promoted smoothly when the speech uttered by the user is barged in. In the case of a visual information being available to be used, lighting a lamp or a gesture of a character agent such as a character showing an action to bend an ear on display can serve as a indicator to show a timing when a user may be permitted to utter a speech.

In the case of a media, in which only an audible information through such a telephone is used in communication, a manner of showing a timing for utterance to a user is known, while the visual information generated by an indicator lamp or the gesture of the character above mentioned cannot be used. That is, a particular tone (sound) to show a caller the timing for a speech by the caller to be able to be recorded in a recorder provided in a telephone answering machine. In this case, the tone serves as a function to prompt the user's speech. In the dialogue between person and the speech dialogue system mentioned above, the dialogue is promoted by that a user answers a speech uttered by the system.

However, for example of the telephone answering machine, the duration of the particular tone is too short that the user (caller) often misses the tone and tends to lose the suitable timing to speak his message. Thus the method to indicate the timing for speaking with the transitory particular tone is not useful in the speech dialogue system in which a barge-in speech uttered by the user is permitted during the utterance of the system.

### SUMMARY OF THE INVENTION

The present invention is based on the conception that the duration of a sign being not transitory but continuous may show clearly the user the timing by which the speech uttered by him or her can be accepted by the system as the response to the speech uttered by the system.

Accordingly the present invention provides a dialogue system that can promote a smooth dialogue between person and the system by prompting the user to speech or indicating a permitted period for the user to utter a speech.

The speech dialogue system includes a speech recognition unit for analyzing and recognizing a speech input to the speech dialogue system, a speech synthesizing unit for synthesize a speech signal responsive to a speech to be uttered, and a sub-sound generating unit for generating a sub-sound signal notifying a state of the speech dialogue system being able to accept a speech input to the speech dialogue system or not.

Further, the speech recognition unit can include echo-canceling function for extracting a speech signal from a received speech including a speech uttered by the user and the system.

Furthermore, the system can include a speech dialogue control unit to control the speech synthesizing unit and the sub-sound generating unit.

Still further, the system can include a microphone for receiving a speech uttered by a user and a loudspeaker for transmitting a speech uttered by the system.

### BRIEF DESCRIPTION OF THE DRAWINGS

FIG. 1 is a schematic diagram of a conventional speech dialogue system;

FIG. 2 is a schematic diagram of the first embodiment according to the present invention;

FIG. 3 is a first flow chart for the operation of the speech dialogue system of the first embodiment;

FIG. 4 is a second flow chart for the operation of the speech dialogue system of the first embodiment;

FIG. 5 is a third flow chart for the operation of the speech dialogue system of the first embodiment;

FIG. 6A is an example showing periods of system utterances;

FIG. 6B is an example showing periods of sub-sound uttered by the speech dialogue system and a time relationship with a system utterance shown in FIG. 6A;

FIG. 7 is an example of a table showing the relation between the sub-sound information and the sound corresponding to the information respectively;

FIG. 8 is a schematic diagram of the second embodiment according to the present invention;

FIG. 9 is a flow chart for the operation of the second embodiment;

FIG. 10 is a schematic relationship between a speech uttered by the speech dialogue system according to the present invention and the speech barged-in spoken by a user;

FIG. 11 is a schematic diagram of the third embodiment according to the present invention;

FIG. 12 is a schematic diagram of the fourth embodiment according to the present invention;

FIG. 13A is an illustration indicating an application to a rice cooker of the present invention;

FIG. 13B is a schematic diagram of the rice cooker shown in FIG. 13A;

FIG. 14 is an illustration indicating an application to a system for communication between a portable telephone and a speech dialogue system according to the present invention.

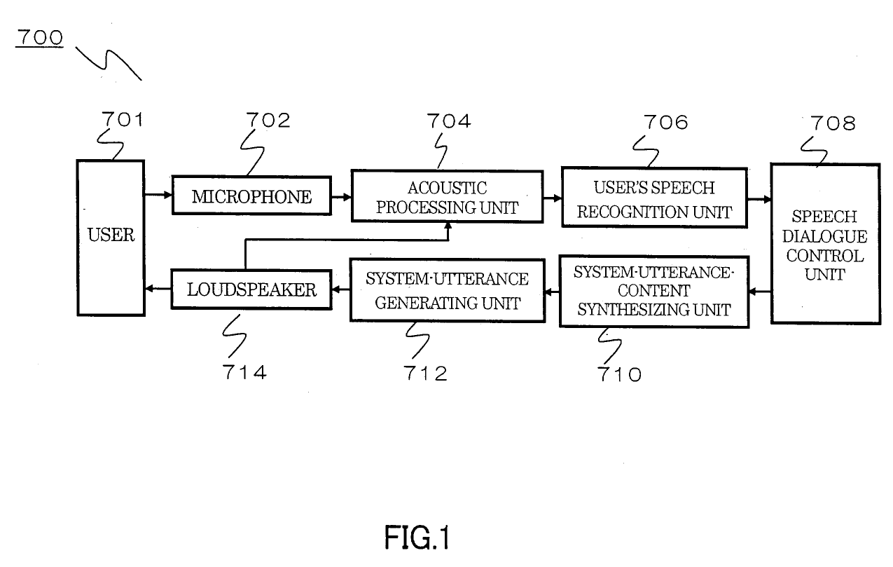

### DETAILED DESCRIPTION OF THE PREFERRED EMBODIMENTS

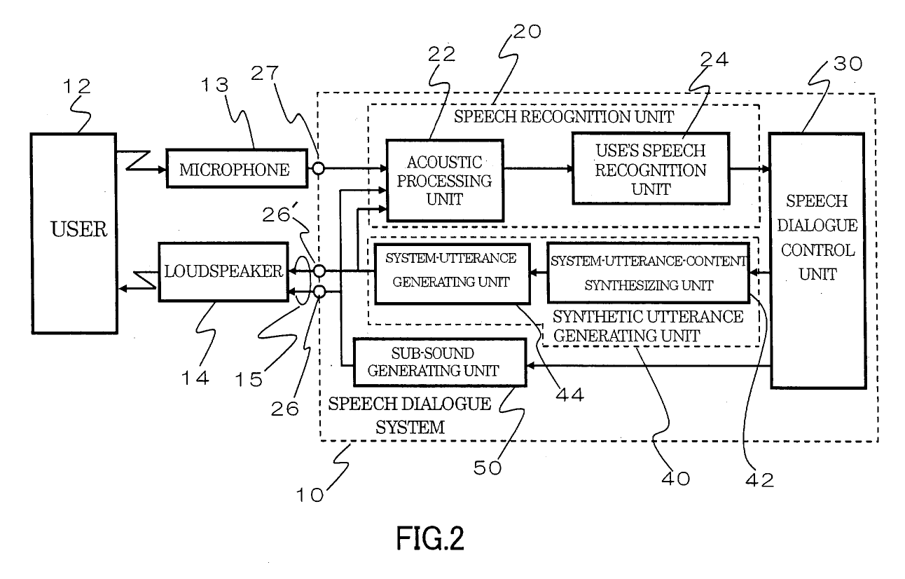

Referring FIGS. 2 to 7, the preferable first embodiment is explained. FIG. 2 shows a schematic diagram of the speech dialogue system 10 as the first embodiment. The system 10 has a microphone 13 as a receiving means of sound or speech uttered by a user 12. The speech input into the microphone 13 is converted to a speech signal, and then sent to an acoustic processing unit 22 within a speech recognition unit 20. The speech input into the microphone 13 probably includes a speech and/or a sub-sound, which is described in detail below, which are radiated with a loudspeaker 14.

The speech and sub-sound uttered by the system 10 can be identified by the system 10, because they are predetermined by the system 10 before being radiated through the loudspeaker 14. So, the signals producing the speech or the sub-sound is sent to the acoustic processing unit 22 from a system-utterance generating unit 44 and a sub-sound generating unit 50 and subtracted from the speech signal from the microphone 13 in the acoustic processing unit 22, the processing of which is referred as echo-canceling process. With the use of the echo-canceling process, the speech signal correspond to the speech uttered by the user 12 is extracted form the speech signal input to the acoustic processing unit 22 from the microphone 13. A level normalizing process is applied as well to the speech signal for improving the recognition rate in process performed in a user's speech recognition unit 24, which is provided in the speech recognition unit 20, connected to the acoustic processing unit 22. It is possible to include the microphone 13 and the loudspeaker 14 in the speech dialogue system 10, while in the first embodiment they are connected to the system 10 with lines 15.

The explanation of echo-canceling is described within the range necessary for understanding this embodiment. The system-speech uttered by the loudspeaker 14 is generated by signals from the system-utterance generating unit 44 and sub-sound generating unit 50. Some amount of the sound radiated from the loudspeaker 14 is input into the system 10 through the loop from the loudspeaker 14 to the microphone 13. The transfer function expressing the loop from the output ports 26, 26′ to input port 27 of the system 10 can be predetermined, therefore the sound component of the sound radiated from the loudspeaker 14 can be expected by the use of the predetermined transfer function. The filter based on the transfer function, for example, is provided within the acoustic processing unit 22 and served for the echo canceling.

Next, the output signal from the acoustic processing unit 22 is analyzed in the user's speech recognition unit 24. The analysis is performed by the use of the vocabulary data which is stored as a database, the vocabulary data is referred as to a recognition dictionary hereinafter. The recognition dictionary includes the vocabulary which is expected such that the user 12 uses in the dialogue with the system 10, and the dictionary is preferably provided within the user's speech recognition unit 24, while it is possible to provide the dictionary in any part if the dictionary can be accessed by the user's speech recognition unit 24. The speech information corresponding to the output signal from the acoustic processing unit 22 is compared with the vocabulary in the dictionary to determine which vocabulary corresponds to the speech uttered by the user 12. The meaning of speech uttered by the user 12 is recognized in this manner, and the resultant information for the speech uttered by the user 12 is fed to a dialogue control unit 30. The dialogue control unit 30 sends the resultant information to a system-utterance-content synthesizing unit 42 in a synthetic utterance generating unit 40.

The dialogue control unit 30 includes a microcomputer for controlling each unit in the system 10 and performing each process in turn, a timer, and a storage means such as a hard disk dive, optical disk drive, semiconductor memory, or so on for storing required program. The system-utterance-content synthesizing unit 42 includes a storage means such as ROM, disk drive, or the like in which a scenario or a logic is stored. The scenario or the logic is for determining the sequence of the system utterances and the system utterance according to the user's speech. For example a hierarchical decision tree can be used as the scenario or the logic for selecting a system utterance according to a user's speech. The system-utterance-content synthesizing unit 42 generates system-utterance information responding to the resultant information received from the dialogue control unit 30 by using the scenario or the logic. The system-utterance information is converted to a signal appropriate to the loudspeaker 14 in the system-utterance generating unit 44 and sent to the loudspeaker 14 via the output line 15.

The scenario or the logic can be stored in the speech dialogue control unit 30, while they are stored in the system-utterance-content synthesizing unit 42 in the configuration described above. In the case of the speech dialogue control unit 30, information about the word or phrase to be synthesized in the system-utterance-content synthesizing unit 42 is fed from the dialogue control unit 30 in which the information is formed with the resultant information from the user's speech recognition unit 24 and the scenario or the logic in the speech dialogue control unit 30.

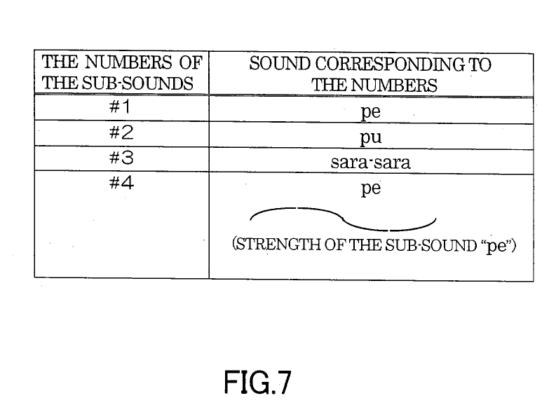

According to an instruction from the dialogue control unit 30, the sub-sound generating unit 50 generates a sub-sound signal suitable to a sound radiated from the loudspeaker 14 and sends the sub-sound signal to the loudspeaker 14 via the output line 15. The sub-sound generating unit 50 has a table shown in FIG. 7, which relates the number of the sub-sound information and the sub-sound-signal information. For example, when the sub-sound information #1 is selected by the instruction from the dialogue control unit 30, the sound “pe” is continuously radiated from the loudspeaker 14. The sub-sound information #4 is related to a sound “pe” of which strength varies like a wave. Though the table in FIG. 7 shows only four kinds of the sub-sound information, it is possible to store the information of other kinds of sub-sounds and the information of speech as natural language such as “please select one of followings.” or “please answer, please answer.” instead of or in addition of the sound “pe”,“pu”, “sara-sara (the sound of a shallow body of water moving lightly)”.

The number of the output lines 15 between the loudspeaker 14 and the speech dialogue system 10 may be one or more, while FIG. 2 shows two lines.

The each processing in the system 10 is preferably performed in a manner of digital signal processing. The speech signal output from the microphone 13 can be converted into digital signal in the microphone 13 or in the acoustic processing unit 22.

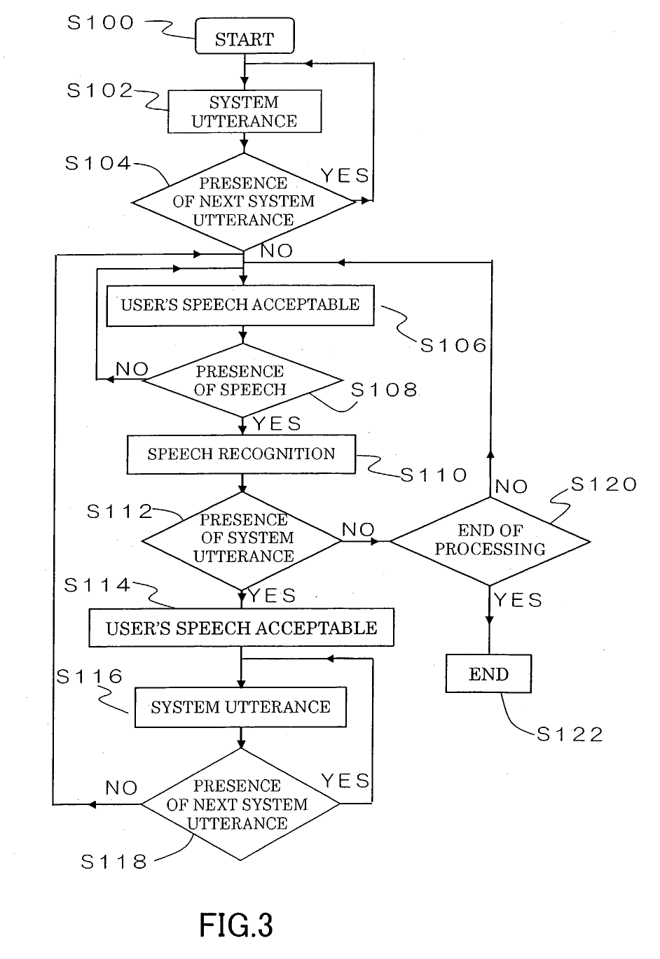

Next, referring to the flow chart shown in FIG. 3, the processing that takes place in the speech dialogue system 10 will be explained. The “S” attached to the reference numbers means “step,” for example, “S100” shows “step 100.”

Initial setting of the system 10 has been performed (step S100), and then a system utterance is transmitted (step S102) in the present embodiment. For example, in step S102, the system utterance;” Thank you very much for using this system. While this “Pe” sounding, the content about which the customer talks to this system can be accepted.” This announcement is notified from the loudspeaker 14 to the user 12 based on the scenario of the dialogue.

And, the presence of the following system utterance is inquired from the speech dialogue control unit 30 to system-utterance- content synthesizing unit 42 (step S104). When the following utterance is presented (for YES in step S104), the processing returns to step S102 again and the following system utterance is uttered.

When there is no following system utterance (for NO in step S104), the speech dialogue control unit 30 instructs the sub-sound generating unit 50 to generate a sub-sound signal to show the system 10 in the state of being possible to accept the speech from the user. The sub-sound generating unit 50 generates a sub-sound signal for the loudspeaker 14 to utter continuously the sound, for example “pe”, showing the state of the system 10 and then sends the sub-sound signal to the loudspeaker 14 (step s106). The speech dialogue control unit 30 monitors the output of the speech recognition unit 20 whether the user's speech is received or not (step S108). Namely, by monitoring the output of the user's speech recognition unit 24, processing turns to step s106 when the output showing occurrence of user's speech is not monitored (for NO in step S108). In this case, the sub-sound generating unit 50 generates continuously the same sub-sound signal to show the system 10 in the state of being possible to accept the speech from the user.

On the contrary, when the output showing occurrence of user's speech is output from the user's speech recognition unit 24 (for YES in step S108), the speech recognition unit 20 performs an operation of recognizing the content of the user's utterance.

According to the result of the recognition, the speech dialogue control unit 30 determines whether the system utterance should be uttered or not. When the system utterance is required (for YES in step S112), the control unit 30 instructs the sub-sound generating unit 50 to generate a sub-sound signal by which the user is notified that the system is not in the state of being possible to accept the speech by the user. The sub-sound showing the system being in “no acceptable” is preferable continuously radiated and different from the sound “pe” or of no sound (step S114).

And in step S116, according to the result of the speech recognition and the scenario of the dialogue, the system-utterance signal is generated in system-utterance-content synthesizing unit 42. The system-utterance signal is transmitted to the loudspeaker 14 for transmitting to the user 12 via the system-utterance generating unit 44. And then, after this utterance, the speech dialogue control unit 30 determines whether there is a next utterance to be uttered or not. When there is a next utterance (for YES in step S118), the processing turns to step S116, and the next system utterance is uttered by the same manner described above. On the contrary, when the next system utterance is determined not to be required (step S118), the processing turns to step S106, and the sub-sound for notifying the user of the state of the system 10 being possible to accept the speech by the user is generated in step S106.

In the step S112, the system utterance is determined not to be required (for NO in step S112), in step S120 whether a series of process of the speech dialogue system 10 is over or not is determined. For example, the speech dialogue control unit 30 monitors whether the last system utterance has been transmitted or not, or occurrence in a predetermined period is monitored or not. In step S120, when the control unit 30 determines that the processing is over (for YES in step S120), the dialogue with the user is ended. On the other hand, in step S120, when the processing is determined to have not been ended, the processing turns to step s106 (for NO in step s120).

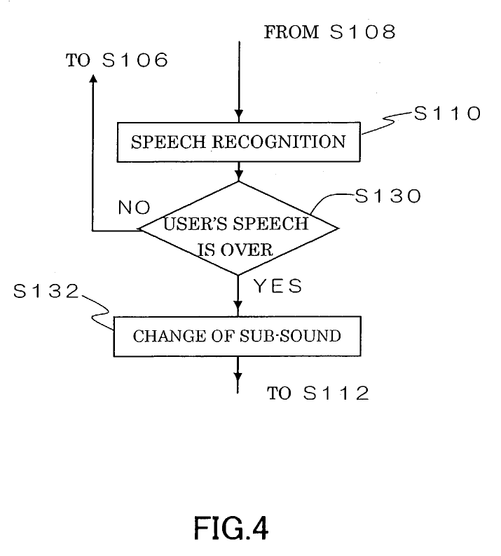

FIG. 4 shows another example of flow chart for the processing of the system 10 in which steps S130 and S132 are added between steps S108 and S112 of the flow chart shown in FIG. 2. In step S130 next to the step S110, processing determines whether the speech by the user 12 is over or not. The determination performed in the speech dialogue control unit 30 can be performed on whether the user has spoken for a predetermined period or not. When the user has not spoken for the predetermined period (for YES in step S130), it is decided that there is no speech by the user. Then, by the use of a sub-sound different from the sub-sound used already, the system 10 notifies the user that the system 10 recognizes the end or termination of the speech by the user. To transmit the different sub-sound from the loudspeaker 14, the control unit 30 directs the sub-sound generating unit 50 to generate a sub-sound signal responsive to the sub-sound signal different from the sub-sound signal for notice of the system 10 being available to accept.

On the other hand, when the user speaks something during the predetermined period measured by the timer in the control unit 30 (for NO in step S130), it is decided that the speech by the user 12 has not been ended or terminated and the processing turns to step s106 (shown in FIG. 3), the sub-sound radiated from the loudspeaker 14 is not changed.

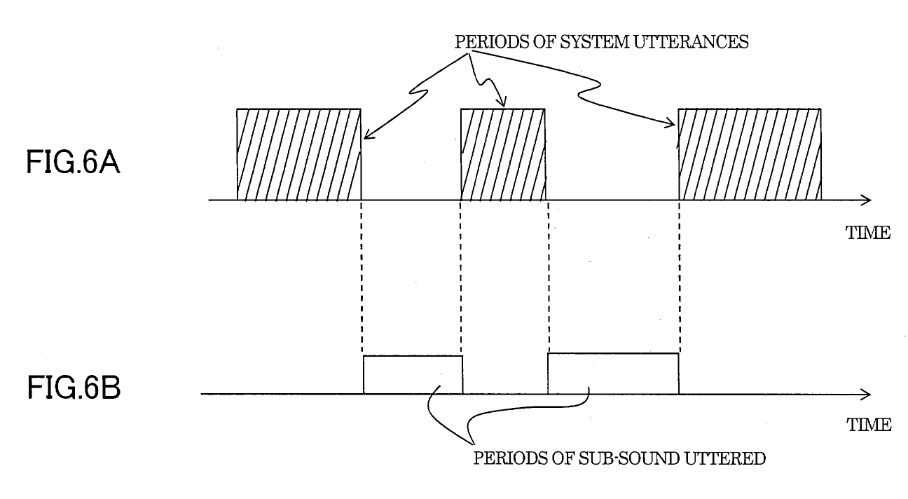

In addition to the explanation described above, FIGS. 6A and 6B shows the temporal relationship between periods of both the system utterance and the sub-sound radiated from the loudspeaker 14. FIG. 6A shows the time sequence of occurrences of the system utterance and FIG. 6B shows the occurrences of the sub-sound. As shown in FIGS. 6A and 6B, the sub-sound is continuously transmitted to the user during each period except the period in which the system utterance is uttered.

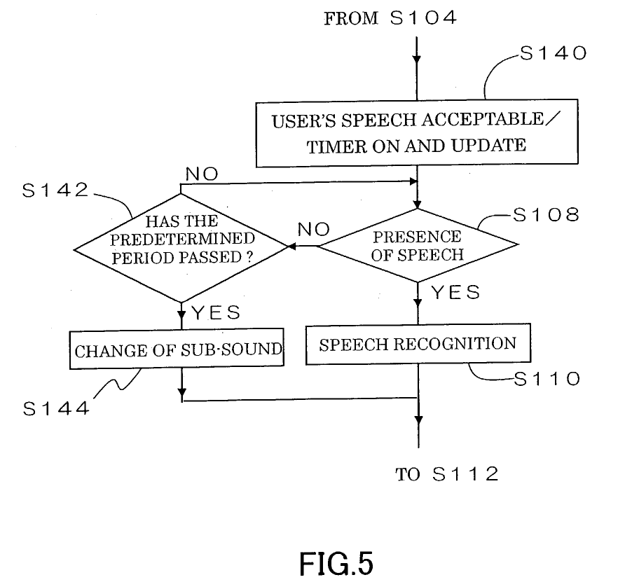

Furthermore, another example of a flow chart of a processing modified from the flow chart shown in FIG. 3 is shown in FIG. 5. The processing by the flow chart shown in FIG. 4 can change the sub-sound based on whether the user 12 has not spoken for a predetermined period after the system 10 has become in the state being possible to accept the speech by the user 12. That is, as the dialogue between the user 12 and the system 10 can be promoted smoothly by the alternative speech of the user 12 and the system 10, the object of the processing of the flow chart shown in FIG. 5 is to urge the user 12 to speak something after the system utterance by changing the sound of the sub-sound. The change of the sub-sound can notify the user 12 that the user's turn has come.

Instead of step S106 in the flow chart shown in FIG. 3, step S140 is performed after step S104, where processing in step S140 is to generate the sub-sound for notifying the system in the state of being possible to accept the speech by the user 12 and to turn the timer on in the dialogue control unit 30. In step S108, the determination is performed according to whether the user 12 has uttered or not. When the determination is NO for step S108, the processing turns to step S142, and a predetermined period is monitored by the timer provided in the dialogue control unit 30. When the predetermined period is monitored by the timer and the speech by the user 12 is no detected, the dialogue control unit 30 instructs the sub-sound generating unit 50 to generate a sub-sound signal different from the sub-sound showing the system 10 in the state of being capable to accept the speech by the user 12.

On the other hand, in step S142 when the predetermined period has not passed (for NO in step S142), the processing turns to step S108. In this case, the sub-sound is not changed and transmitted to the user 12.

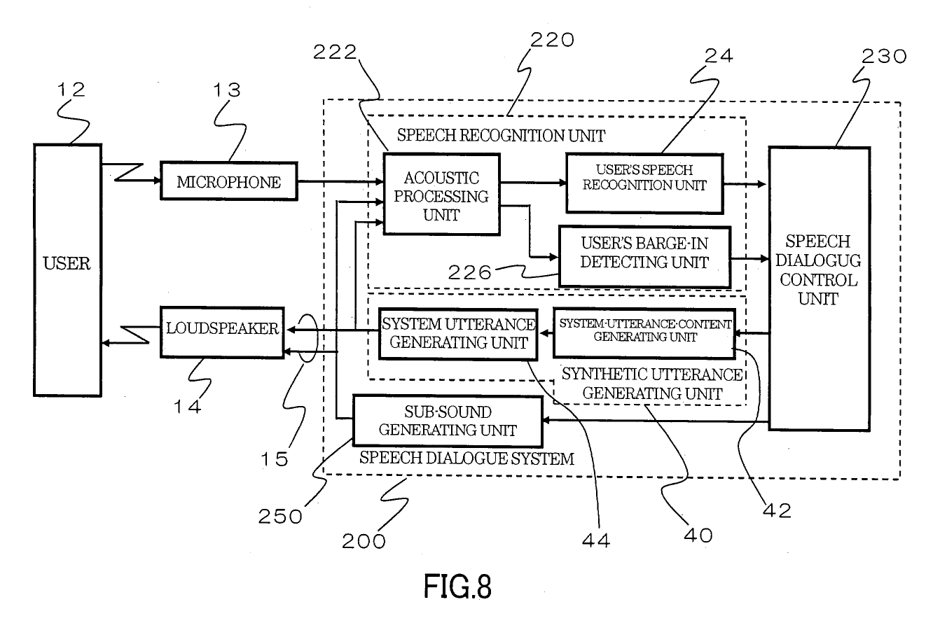

Next, the second embodiment is explained referring to FIGS. 8 to 10. Same part or unit in FIG. 8 equivalent to one in FIG. 2 is noted by the same numeral and the explanation for the part or unit is omitted. FIG. 8 shows a schematic block diagram of a speech dialogue system 200. The system 200 has a function which can make possible the system 200 accept the speech by the user 12 while the system 200 is uttering the system utterance. The function is referred as to “barge-in.”

Generally for performing the barge-in function in the system 200, to recognize the content of the user's speech received by the system 200 while the system 200 is uttering, the recognizing function, for example the recognition dictionary, of the user's recognition unit 24 is changed according to the expected speech of the user 12 in a certain case. After the changing the recognizing function, the content of the speech uttered by the user 12 can be recognized. Namely the speech uttered by the user 12 can be accepted by the system 200. At the time when the speech by the user 12 is possible to be accepted by the system 200, a dialogue control unit 230 instructs a sub-sound generating unit 250 to generate a sub-sound showing the system 200 in the state of being possible to accept the speech uttered by the user 12.

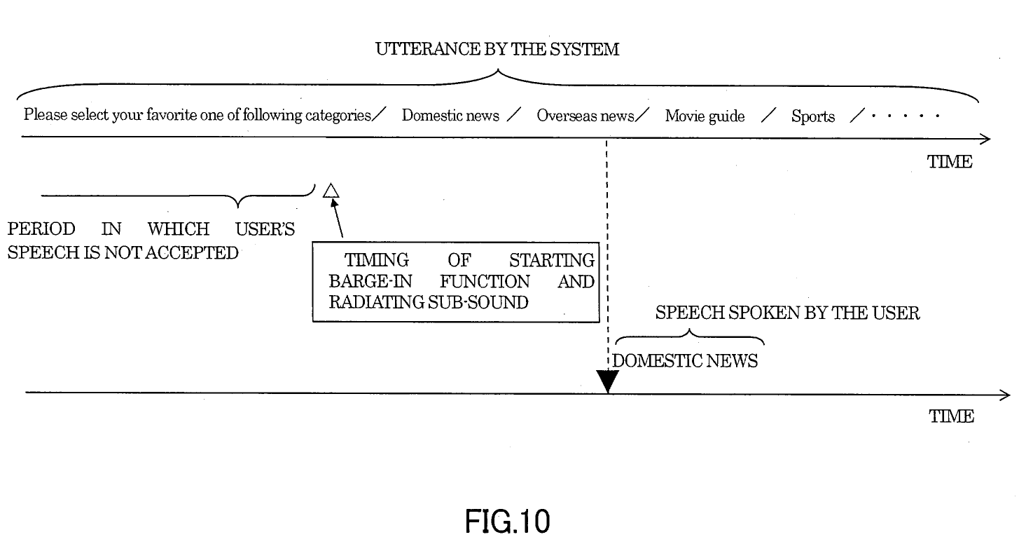

An example of the dialogue using the barge-in function is shown in FIG. 10. FIG. 10 shows the example of a relationship between the utterance by the system 200 and the speech uttered by the user 12 where the speech barges in the utterance such as an announcement uttered by the system 200. Each horizontal axis indicates the time elapse. The example shows the utterances, which are the categories of the information uttered by the system 200. The categories which provides information of domestic news, overseas news, or movie guide and so on where the signs “/” inserted between the system utterances are used to show the period of no utterance by the system 200. Then the system 200 utters in turn “Please select your favorite one of following categories,” “Domestic news,” “Overseas news,” “Movie guide,” “Sports.” If the user 12 wants to know the information about domestic news, the user 12 speaks “domestic news” during “overseas news” being uttered by the system 200. The staring time of “domestic new” spoken by the user 12 is shown by the symbol ▾ in FIG. 10.

“Please select your favorite one of following categories,” “Domestic news,” “Overseas news,” “Movie guide,” “Sports” are uttered based on the predetermined scenario. As the user 12 is predicated to select and speak one of these system utterances, the recognition dictionary for recognition provided in the user's speech recognition unit 24 has been changed to the dictionary including speech predicated to be uttered by the user 12. Using the dictionary including the vocabulary predicated to be used by the user 12 allows high speed speech recognition.

Even in this case shown in FIG. 10, for a time required to change the recognition dictionary, the system 200 can not respond to the speech input by the user 12, that is, the duration for necessary time to change the recognition dictionary is a period in which the speech by the user 12 is not accepted.

Accordingly in this second embodiment, to show clearly the user 12 whether the system is in the state to accept a speech by the user 12 or not, a sub-sound is radiated when the barge-in function comes to be in operative.

Next, the speech dialogue system 200 as the second embodiment is explained in detail. The system 200 comprises a speech recognition unit 220, a speech dialogue control unit 230, the synthetic utterance generating unit 40, and a sub-sound generating unit 250.

In the second embodiment, a user's speech recognition unit 24 having a recognition dictionary is provided in the speech recognition unit 220 as like as the first embodiment. According to the system utterance or the system utterance to be uttered, the recognition dictionary is changed. A signal corresponding to the change of the dictionary is sent to the speech dialogue control unit 230 and then the speech dialogue control unit 230 sends an instruction to the sub-sound generating unit 250 to generate a sub-sound which notifies the user 12 that the system 200 is in the state of being capable to accept the speech by the user 12. In spite of the method mentioned above for generating the sub-sound, it is also preferable to generate the sub-sound for notifying the acceptable state of the system 200 at the timing described in the scenario or the logic. Further it is also preferable to generate the sub-sound automatically by the predetermined timing stored in the dialogue control unit 230.

The acoustic processing unit 222 has a similar function to the acoustic processing unit 22 in the first embodiment, the speech signal uttered by the user 12 converted by the microphone 13 is monitored by the user's barge-in detecting unit 226, which can detect the speech signal by the user 12 even if the system utterance is radiated from the loudspeaker 14. When the speech signal by the user 12 is detected by the detecting unit 226, the interruption signal is sent to the dialogue control unit 230 from the user's barge-in detecting unit 226.

It is preferable to provide the microphone 13 and/or the loudspeaker 14 within the system 200.

When the interruption signal is input to the dialogue control unit 230, the control unit 230 instructs to the system utterance-content synthesizing unit 42 to generating an utterance to be uttered based on the speeches which have been uttered from the system 200 and the recognized content of the speech barged in by the user 12. The system-utterance-content generalized in the synthesizing unit 42 is sent to the system utterance generating unit 44, converted in an appropriate form to the loudspeaker 14 and sent to the loudspeaker 14. On receiving the interruption signal, the dialogue control unit 230 also instructs the sub-sound generating unit 250 to change the sub-sound. And then the sub-sound generating unit 250 changes the sub-sound to a sub-sound for notifying that the system 200 has received the user's speech.

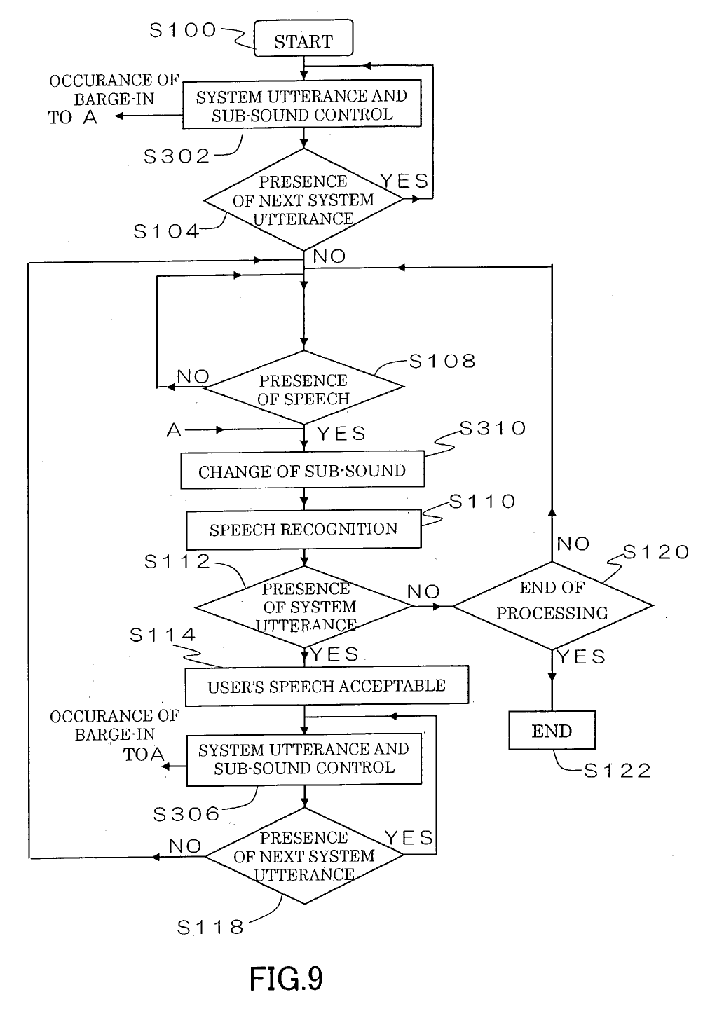

Referring to FIG. 9, the processing of the system 200 is explained. Steps noted same reference number perform the same processing of the flow chart in FIG. 3, and the operation of the processing are omitted for the simplicity.

The barge-in function is a function by which the system 200 can received and recognized the speech uttered by the user 12 as described above. In steps S302 and S306 corresponding to steps S102 and S116 respectively in FIG. 3, the sub-sound is generated when the system 200 turns to the state of being able to accept the user's speech. And in steps S302 and S306, when the interruption based on the speech by the user 12 occurs, processing turns to step S310. In step S310, the dialogue control unit 230 instructs the sub-sound generating unit 250 to generate a sub-sound different from the sub-sound being radiated from the loudspeaker 14, and then the sub-sound radiated from the loudspeaker 14 is changed.

In the second embodiment, in steps S302 and 306, the system 200 can transmit the sub-sound when the user's speech is permitted to be received, so the step S106 in FIG. 3 becomes unnecessary.

By the second embodiment, the user 12 can respond to the speech dialogue system 200, while the user 12 listens to the utterances uttered by the system 200. In the case shown in FIG. 10, for example, if the user 12 has known the menu of service, the user 12 can tell a desired menu when the user 12 hears the sub-sound notifying that the system 200 comes to be in the state of being able to accept the user's utterance, even before the announcement (utterance by the system) speaks the user's desired menu. For example, after the timing marked by Δ, the user can tell the desired menu, such as “Sports.”

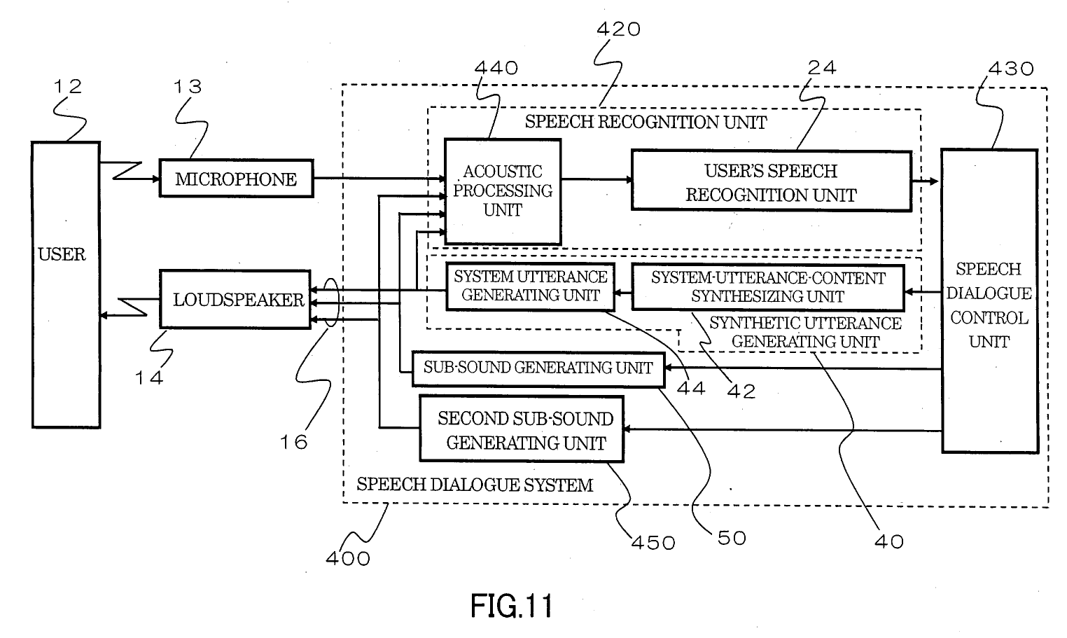

Next, referring to FIG. 11, the third embodiment of the present invention is explained. In FIG. 11, the parts or unit which has same function as one in FIG. 2 has similar reference number. The third embodiment of a speech dialogue system 400 has a speech recognition unit 420, a speech dialogue control unit 430, the synthetic utterance generating unit 40, the sub-sound generating unit 50, and a second sub-sound generating unit 450.

The system 400 differs the system 10 in that the system 400 has the sub-sound generating unit 50 and the second sub-sound generating unit 450. And the sub-sound generating unit 50 is used for the dialog between the user 12 and the system 400 as described in the first embodiment. The second sub-sound generating unit 450 is used to generate a sub-sound to notify the user 12 of the degree of progress in the task to be performed by the system 400. For example, the sound radiated from the loudspeaker 14 corresponding to the second sub-sound is one of the tones in the musical scale, where the sound from the loudspeaker 14 will be changed to a higher tone when the task progresses to one higher step. By the use of the second sub-sound, the user 12 can know consciously or unconsciously the state of the progress of the dialog or how long the dialog will take to the end. The system shown in FIG. 11 is connected to the microphone 13 and the loudspeaker 14 outside of the system 400, while it is possible that the microphone 13 and/or the loudspeaker 14 are included within the system 400.

The system 400 also has an echo-canceling function described above, where the output signal of the second sub-sound generating unit 450 is sent to the acoustic processing unit 440 for echo-canceling.

Further, though the output lines 16 is shown as plural lines, it is possible to use a single or pair line as an output line 16.

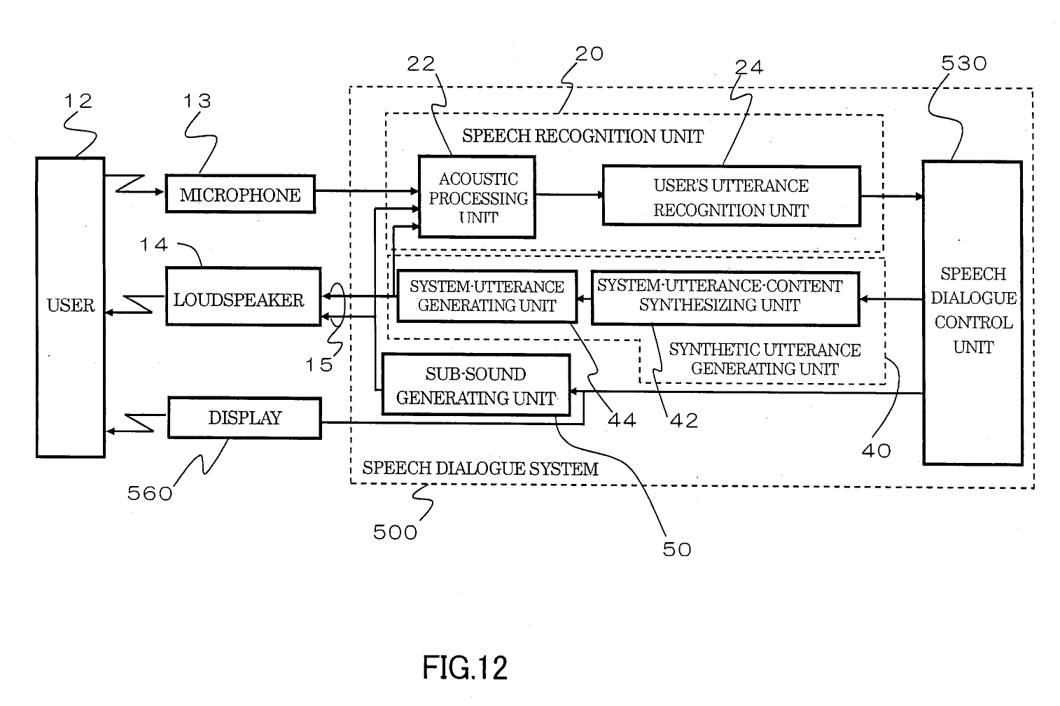

Next, referring to FIG. 12, the fourth embodiment of the present invention is explained. In FIG. 12, the parts or unit which has same function as one in FIG. 2 has similar reference number. The speech dialogue system 500 as the fourth embodiment has the speech recognition unit 20, a speech dialogue control unit 530, the synthetic utterance generating unit 40, and the sub-sound generating unit 50. The system 500 differs the other systems 10, 200, or 400 in that the system 500 has the dialogue control unit 530 which can send the instruction corresponding to the instruction to the sub-sound generating unit 50 to generate a signal to be sent to a display 560. The user 12 can know auditorily and visibly whether the system 500 can accept the speech by the user 12 or not. AS the display 560, CRT or a lamp using light emitting diode may be used. In the case of using the CRT, it is preferable to display a character which shows the state of the system 500. In the case of using the light emitting diode, it is preferable to show the state of the system 500 by the variation of period of on and off. The system shown in FIG. 12 is connected to the microphone 13 and the loudspeaker 14 outside of the system 500, while it is possible that the microphone 13 and/or the loudspeaker 14 are included within the system 500.

In the second to the fourth embodiments, it is possible to store the scenario or logic in the speech dialogue control units 230, 430, and 530. In these cases, information about the word or phrase to be synthesized in the system-utterance-content synthesizing unit 42 is fed from the dialogue control units 230, 430, 530 respectively in which the information is formed with the resultant information from the user's speech recognition unit 24 in each speech dialogue system and the scenario or the logic in the speech dialogue control units 230, 430, 530. Further, in each embodiment, it is possible to provide loudspeakers 14 for separately radiating the system utterance and the sub-sound.

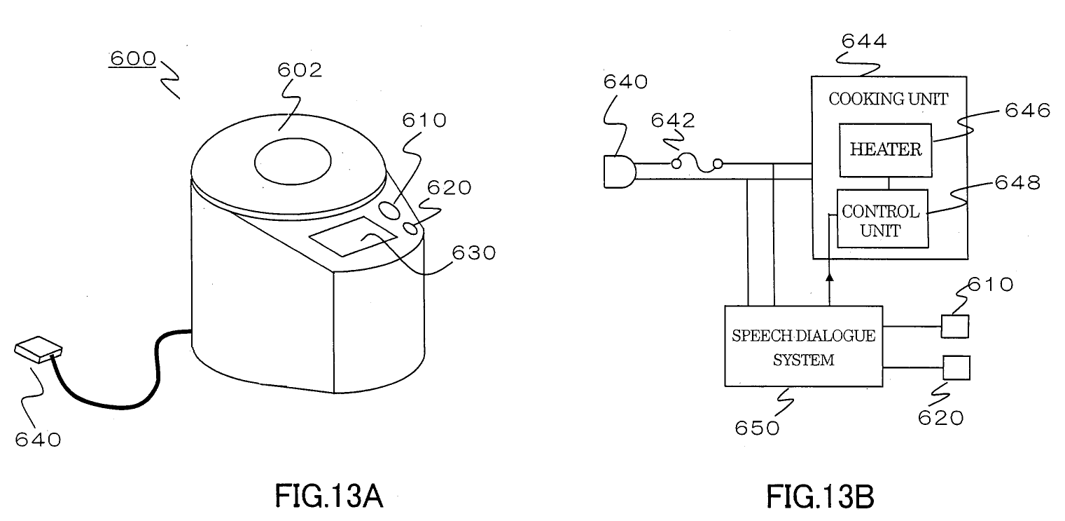

Next, referring to FIGS. 13A and 13B, an application of the present invention is explained. FIG. 13A shows a schematic outer view of a rice cooker 600 which is used to boil rice by electric power. A lid 602 is provided at the upper part of the cooker 600. An operation panel 603 is provided at the top surface of the project part of the cooker 600. On the operation panel 603, a loudspeaker 610, a microphone 620, and a display 630 are provided. A power cable having a plug 640 at one end is connected to the rice cooker 600. The speech dialogue system 650 installed in the cooker 600 is provided within the projected part of the cooker 600. FIG. 13B shows schematically a main part of the cooker 600, such as a circuit and the system 650. A fuse 642 is provided one of a pair lines as a power cable. Via the power cable, the power is supplied to the system 650, and to a cooking unit 644 including a heater unit 646 for boiling rice and a control unit 648 for controlling the heater unit 646.

The loudspeaker 610 and the microphone 620 are connected to the system 650, and the signal from the speech dialogue control unit (not shown) in the system 650 is output to the control unit 648.

As described above, by the use of the sub-sound or the variation of the sub-sound, the present invention notifies the user whether the speech dialogue system 650 is in the state of being able to accept the speech by the user or not. The user, therefore, easily know the timing permitted to speak a response to the system 650, and the dialogue between the user and the system will be smoothly proceed.

The function of the system 650 is analogous to the function of the system 10 in the first embodiment. When a power switch (not shown) is turned, the speech “Please tell the time for the cooking to be finished” is uttered by the loudspeaker 610, and at the same time the sub-sound, for example, “pe,pe,pe,-------” is uttered continuously from the loudspeaker 610. The user (not shown) speaks “The time is 6:30 in next morning.” The speech by the user is processed in the system 650 to recognize the content of the speech, and the sub-sound is stopped. And then the speech “The time for finishing the cooking is set at 6:30 in next morning. Is it OK?” is uttered by the loudspeaker 610.

The control signal corresponding to the time set to finish the cooking is sent to the control unit 648 from the speech dialogue unit 650. The time for turning-on the heater 646 to complete the cooking at the indicated time is calculated in the control unit 648, and stored. At the time calculated, the signal to turn-on the heater 646 is sent to the heater 646 from the control unit 648.

Further, the time for finishing the cooking is displayed on the display 630 in this application.

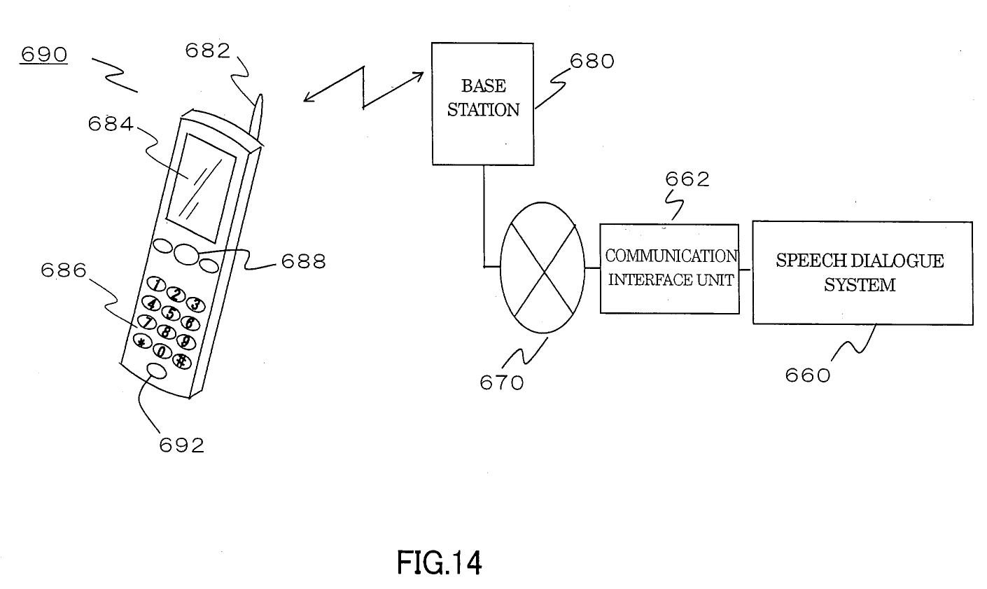

Next, referring to FIG. 14, another application of the present invention is explained. FIG. 14 shows an application of the speech dialogue system 660 connected to a network 670 via communication interface unit 662. The system 660 can communicate with a portable phone 690 or a cellular phone via a base station 680 and the network 670, such as internet, where the communication between the base station 680 and the telephone 690 can be done in a manner of wireless. Between the telephone 690 and the speech dialogue system 660, a speech dialogue is available. The portable phone 690 has an antenna 682 for receiving and transmitting wave from/to the base station 680, a keyboard 686, a display 684 for displaying plural images, a microphone 692 for inputting the speech uttered by the user, and a loudspeaker 688 for transmit the speech uttered by the speech dialogue system 660.

The connection between the portable phone 690 and the speech dialogue system 660 is started by entering the address number assigned to the system 660 by the user. When the connection is established, the dialogue between the user and the system 660 is started. As the system 660, the systems 10, 200, or 400 are available. In this application, the system 660 transmits a sub-sound signal to the portable phone 690 to utter the system speech from the loudspeaker 688.

As is shown above, the dialogue between the user and the speech dialogue system 660 via the network 670 can also use the sub-sound which can promote the smooth dialogue between them.

What is claimed is:

1. A speech dialogue system comprising:
a sub-sound generating unit for generating a sub-sound signal for notifying whether the speech dialogue is in a state of being able to accept the input speech signal or not.

2. A speech dialogue system comprising:
a speech recognition unit for analyzing and recognizing a speech input to the speech dialogue system;
a synthetic utterance generating unit for synthesizing speech signal corresponding to a speech contents to be uttered; and
a sub-sound generating unit for generating a sub-sound signal notifying a state of the speech dialogue system being able to accept a speech input to the speech dialogue system or not, the sub-sound signal being continuously generating during a period of the state.

3. A speech dialogue system according to claim 2, wherein the sub-sound generation unit generates a same sub-sound signal during the state of the speech dialogue system being unchanged.

4. A speech dialogue system according to claim 2, further comprising:
a speech dialogue control unit instructing the speech synthesizing unit to synthesize a speech signal to be uttered by the system according to a result by recognizing the speech in the recognition unit, and the sub-sound generating unit to generating a sub-sound signal.

5. A speech dialogue system according to claim 2, further comprising:
a sound receiving means for receiving a sound;
a first sound radiating means for radiating the system-utterance; and
a second sound radiating means for radiating a sub-sound according to the sub-sound signal.

6. A speech dialogue system according to claim 2, further comprising:
a sound receiving means for receiving a sound;
a sound radiating means for radiating the system-utterance and a sub-sound according to the sub-sound signal.

7. A speech dialogue system according claim 2, wherein a received speech signal to the speech recognition unit is analyzed and recognized in the speech recognition unit during a predetermined sub-sound signal is output from the sub-sound generating unit.

8. A speech dialogue system according to claim 2, wherein a received speech signal to the speech recognition unit is analyzed and recognized in the speech recognition unit during a predetermined sub-sound signal is not output.

9. A speech dialogue system according to claim 2, wherein the sub-sound generating unit generates a first sub-sound signal for indicating the speech recognition unit in the state of being able to accept a input speech signal and a second sub-sound signal for indicating the speech recognition unit in the state of being unable to accept the input speech signal.

10. A speech dialogue system according to claim 2, wherein the sub-sound signal generated in the sub-sound generating unit differs when the sub-sound signal generating before or after the time of detecting the speech input into the speech recognition unit.

11. A speech dialogue system according to claim 2, wherein the sub-sound generating unit generate a third sub-sound signal different from a fourth sub-sound, where the third sub-sound is generated when the speech recognition unit does not detect a speech signal to be input for a predetermined period or an end of speech signal input is detected by the speech recognition unit, and the fourth sub-sound signal is generated when the speech recognition unit detects a input speech signal for the predetermined period or a speech signal input has not been ended by the speech recognition unit.

12. A speech dialogue system according to claim 2, the sub-sound signal varies in accordance to elapse of time.

13. A speech dialogue system according to claim 2, comprising:
a display for displaying information corresponding to information corresponding to the sub-sound signal.

14. A speech dialogue system being able to receive a speech signal and to utter an utterance comprising:
an acoustic processing unit for signal-processing the received speech signal:
a user's speech recognition unit for recognizing a content including in the received speech signal and generating a content of the received speech signal:
a system-utterance content synthesizing unit for synthesizing a system utterance:
a system-utterance generating unit for converting the system utterance to an utterance signal:
a sub-sound signal generating unit for generating a sub-sound:
a speech dialogue control unit for instructing the system-utterance content synthesizing unit to synthesize the system utterance based on the content generated in the user's speech recognition unit and for instructing the sub-sound signal generating unit to generate a sub-sound signal or to stop generating a sub-sound signal.

15. A speech dialogue system according to claim 14, further comprising:
a recognition dictionary included in the user's speech recognition unit, being for the use of recognizing the signal processed by the acoustic processing unit;
a scenario for determining a content and/or an order of speech-utterances generated in the system-utterance-content generating unit, being stored in the system-utterance-content synthesizing unit or the speech dialogue control unit, and the system utterance generating in the use of the scenario and the content generated in the user's speech recognition unit; and a sub-sound information for determining a sub-sound signal generated in the sub-sound unit being stored in the speech dialogue control unit or the sub-sound generating unit.

16. A method of a speech dialogue system comprising:
recognizing a speech spoken by a user;
generating a system utterance uttered by the speech dialogue system; and
instructing a generation of a sub-sound uttered by the speech dialogue system during the speech is recognized by the speech dialogue system.

17. A speech dialogue system according to claim 2, wherein the speech recognition unit has an echo-canceling function which extracts a speech uttered by a user from the speech input.

18. A speech dialogue system according to claim 2, wherein a speech into to the speech recognition unit, a speech uttered by the speech dialogue system, and the sub-sound transmitted from the speech dialogue system are communicated via a network.
